(19) United States
(12) Patent Application Publication
(10) Pub. No.: US 2006/0184374 A1
(43) Pub. Date: Aug. 17, 2006

(54) Data collection, identification, and notification system

(75) Inventor: Brian K. Long, Orono, MN (US)

Correspondence Address: SCHWEGMAN, LUNDBERG, WOESSNER & KLUTH, P.A., P.O. BOX 2938, MINNEAPOLIS, MN, 55402, US

(73) Assignee: First Movers Advantage, LLC

(21) Appl. No.: 11/057,306

(22) Filed: Feb. 11, 2005

(51) Int. Cl. G06Q 99/00

(52) U.S. Cl. 705/1

(57) ABSTRACT

A system including a processor and a memory coupled to the processor. The memory has stored therein a property offering database of properties for sale, a client database, and a contact database, wherein each contact is associated with a client. The system further includes software stored in the memory and operable on the processor to cause the system to identify properties for sale owned by contacts as a function of matching a property for sale from the property offering database with a contact from the contact database and generate a report for each client in the client database having one or more identified contacts with a property for sale. Some embodiments further include communicating the reports to the clients.

### TECHNICAL FIELD

The inventive subject matter relates to data monitoring and mining and, more particularly, to a data collection, identification, and notification system.

### BACKGROUND

Information about properties for sale is available from many advertising sources. However, each advertising source includes a unique set of properties for sale including only a portion of all properties for sale in a given market. This forces parties interested in a more complete picture of a real estate market to comb many sources. However, this can be a very time consuming process. Further, some parties may only be interested in certain properties. Combing the numerous advertising sources for these particular properties becomes a laborious, error prone process.

### BRIEF DESCRIPTION OF THE DRAWINGS

FIG. 1 is a system data flow diagram according to an example embodiment.

FIG. 2 is a block diagram of a system according to an example embodiment.

FIG. 3 is a block diagram of a method according to an example embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed. The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. The term “computer readable medium” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, application specific integrated circuit (ASIC), microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

Some embodiments are implemented in a networked computing environment. The network of these embodiments can be a local area network (LAN), a wide area network (WAN), a system area network (SAN), a value added network (VAN), a regional or global network such as the Internet, or virtually any other network capable of carrying data between computing resources. Some further embodiments include a combined interconnection of two or more of these network types. Thus, the exemplary systems and methods can operate not only in a standalone configuration, but also within virtually any networked computing environment.

Embodiments of the present inventive subject matter operate to identify properties offered for sale by a certain group of individuals. In some embodiments, the group of individuals includes contact lists where the owners of the contact lists want to know when a member of their contact list offers a property for sale. The owner of the contact list can be the operator of a system according to one or more of the embodiments described herein or a client of a system operator. Contact list owners are referred to herein as clients.

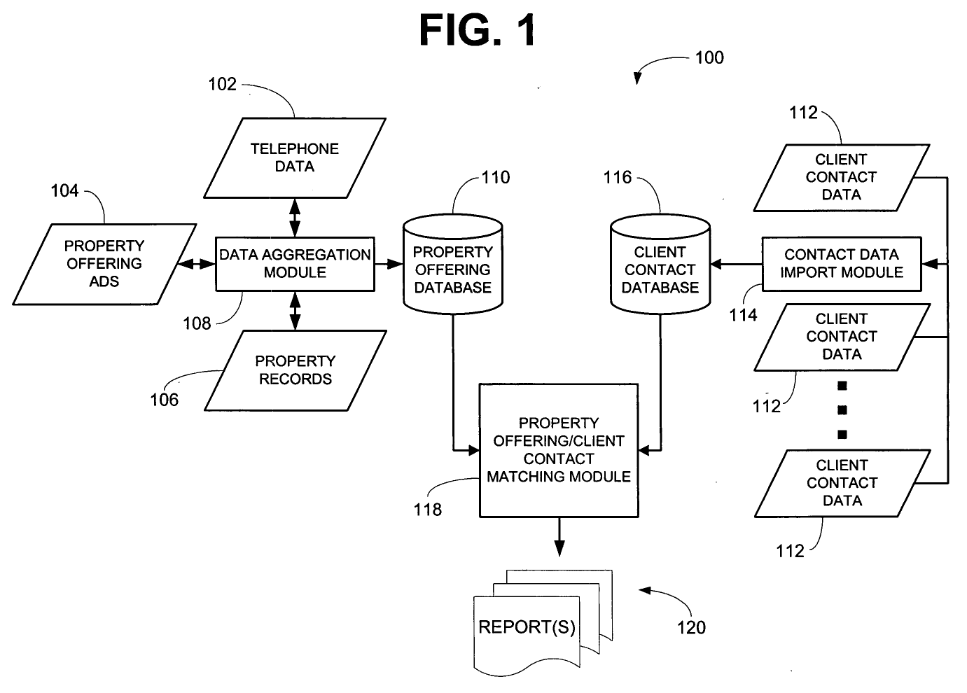

FIG. 1 is a system 100 data flow diagram according to an example embodiment. The system 100 includes a data aggregation module 108, a contact data import module 114, a property offering database 110, a client contact database 116, and a property offering/client contact matching module 118. These elements of the system 100 work in concert to determine when a client contact has offered a property for sale.

The property offering database 110 and the client contact database 116 can be the same database with the client contact data in one or a set of tables and the property offering data in a separate table or set of tables. In some embodiments, the databases of the property offering database 110 and the client contact database 116 are one or more commercially available relational databases. In other embodiments, the databases are flat files, spreadsheets, hierarchical databases, or other data storage formats or systems capable of storing the data in a readable, writeable, and deletable fashion.

The data aggregation module 108 obtains or receives data from one or more data sources. In some embodiments, the data sources include telephone data 102, publicly available property offering advertisements 104, and property records 106. The data aggregation module 108 aggregates data from the various sources and stores the data in a property offering database 110.

In some embodiments, the data aggregation module 108 obtains and receives data of properties for sale from publicly available property offering advertisements 104. The property offering advertisements 104 include printed advertisements, such as newspaper classified ads, and electronic advertisements from one or more publicly available websites. The data aggregation module 108, in some embodiments, obtains and/or receives data including an address of a property for sale. Some further embodiments also obtain and/or receive an asking price of the property for sale.

After the data aggregation module 108 receives or obtains a property offering, the data aggregation module 108 retrieves ownership data of the offered property. The data aggregation module can obtain the ownership data from one or more of several sources such as telephone data 102 and property records 106. The telephone data 102 is a telephone directory data source that includes names, addresses, and telephone numbers. The property records 106 are public records of property ownership such as records maintained by a governmental entity. The property records 106 are available directly from some governmental entities and from property record clearinghouse services. The data aggregation module 108 retrieves property owner names from the telephone data 102 and the property records 106 based on the address of the offered property. Some embodiments also obtain telephone numbers of property owners.

The contact data import module 114 imports client contact data 112 from one or more clients into the client contact database 116. The client contact data 112 is provided by or made available over a network by clients of an entity offering the service of the system 100. In some such embodiments, clients can provide a computer readable file with the contact data or a contact list, the data of which is manually input into the client contact database 1116. The client contact data includes names and addresses of client contacts. In some embodiments, the client contact data also includes a contact telephone number and a contact source identifier that identifies the client from which the contact data is received.

The property offering/client contact matching module 118 operates within the system to identify client contacts from the client contact database 116 having properties offered for sale. The property offering/client contact matching module 118 identifies a match between a client contact property and an offered property in the property offering database 110 based on property addresses. The property offering/client contact matching module 118 further confirms matches based on property owner names and client contact names.

In some embodiments, the address matching includes matching addresses between the property offering database 110 and the client contact database 116 with a combination of one or more of a street number, a street name, city, state, zip code. In other embodiments, the address matching is based on a unique property identifier such as a unique eleven-digit number assigned to every mailing address in the United States and its territories by the United States Postal Service.

When an address match is identified, the match is confirmed as a function of property owner names associated with an offered property in the property offering database 110 and client contact names in the client contact database 116. In some embodiments, the name or names associated with a matched offered property and client contact are retrieved by the property offering/client contact matching module 118 from the property offering database 110 and the client contact database 116.

The retrieved names are then compared to determine if there is a match. In some embodiments, an exact match is not required. For example, one embodiment requires only a match between last names is required to verify a match. Other embodiments verify a match when the first letter of the first names match and the last names are similar. Other embodiments allow for variations of name spelling and common nicknames, such as verifying a match between first names such as Jack and John or Mary and Marilyn, or between last names such as Stuart and Stewart or Schmidt and Schmitt. Still further embodiments include scoring techniques that verify matches if a certain score is obtained in the name matching. Yet another embodiment generates a report of questionable matches to allow for review by a system 100 operator or a client.

Identified matches between offered properties and client contact are subsequently output by the property offering/client contact matching module 118. The output in some embodiments is in the form of one or more reports 120. The reports include a listing of properties offered for sale and the client contact owning the property. In some embodiments, a report is generated for each client that has client contact data in the client contact database 116. In various embodiments, the reports 120 are printed on paper, stored electronically to display on a system 100 user interface such as a web page accessible over a network, or sent in an email to the client providing the contact a for which a match was identified. Other embodiments include other formats of reports sufficient to notify a client of an identified contact with a property for sale.

In some embodiments, the property offering/client contact matching module 118 reports an identified match to a client only once. In these embodiments, the client reports include a list of client and properties that have been offered their property for sale since the last generated report. Other embodiments include reporting an identified match to a client upon a verified match and upon identification of a property offering price change. Yet further embodiments include reporting verified matches for a period, such as ninety days.

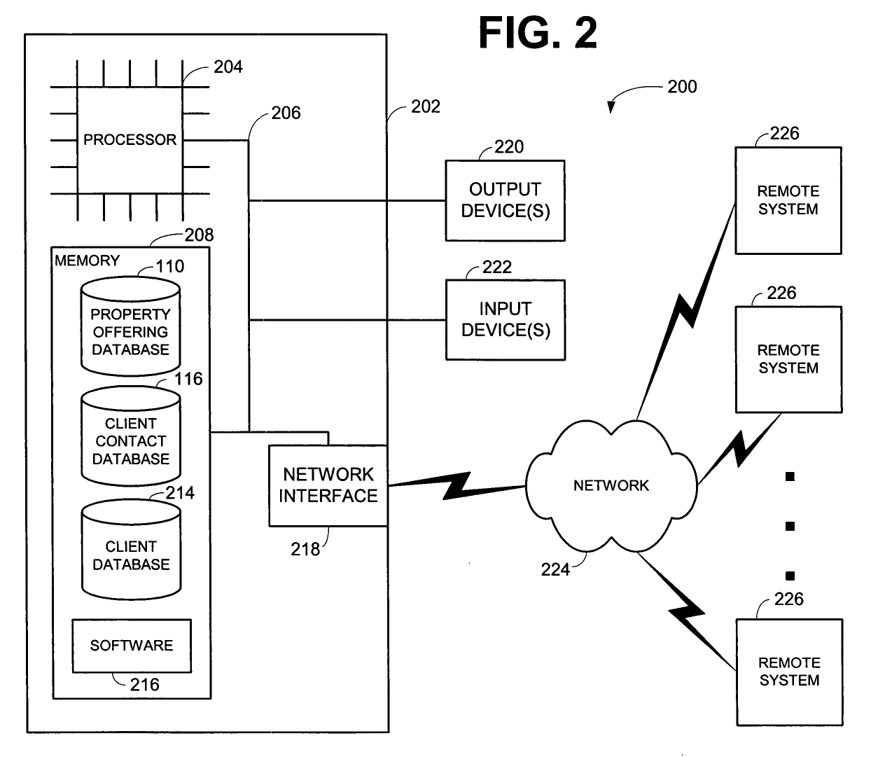

FIG. 2 is a block diagram of a system 200 according to an example embodiment. The system 200 illustrates an example computing environment within which the present inventive subject matter can be practiced. The system 200 includes a computing device 202 connected to a network 224. The computing device includes a bus 206 that operably interconnects a processor 204, a memory 208, a network interface 218, output devices 220, and input devices 222.

The network 224 is an interconnection of computing resources. The network includes a number of remote systems 226 that make data available to and/or request data from other remote systems 226 and the computing 202 over the network 224. Some remote systems 226 include property offering advertisements that are publicly available in an electronic format to network 224 requestors. Other remote systems include property ownership data that is available electronically, either publicly or for a fee, to network 224 requestors. Yet other remote systems 226 are systems of mortgage brokers, moving services, landscaping services, and other service and merchandise providers.

In some embodiments, the computing device 202 is a personal computer, such as a desktop or laptop computer. In other embodiments, the computing device 202 is a server class device. In yet further embodiments, the computing device is two or more devices interconnected over a network, such as network 224, that are operably connected to perform similarly to a single device. For example, some embodiments include the property offering database 110 and the client contact database 116 stored in a memory of one or more database servers separate from the computing device 202.

The processor 204 of the computing device represents a digital signal processor or processing unit of any type of architecture, such as an ASIC (Application-Specific Integrated Circuit), a CISC (Complex Instruction Set Computing), RISC (Reduced Instruction Set Computing), VLIW (Very Long Instruction Word), or hybrid architecture, although any appropriate processor may be used. The processor 204 executes instructions. The processor 204 also includes a control unit that organizes data and program storage in the memory 208 and transfers data and other information in and out of the computing device 202 and to and from the network 224 over the network interface 218.

In some embodiments, the processor module 204 executes software 216 instructions to cause the computing device to operate to receive and obtain data over the network interface 218 and from one or more input devices 222. The software 216 instructions further cause the processor to store the received and obtained data in memory 208 locations such as the property offering database 110 and the client contact database 116.

The output device 220 includes one or more devices connected to the computing device via the bus 206. Some such output devices include a video display, an audio output device such as a speaker, a printer, or other device to output representations of signals generated by the software 216 instructions operating on the processor 204.

The input device 222 includes one or more devices connected to the computing device via the bus 206. Some such input devices include a key board, a pointing device such as a mouse or touch-pad, a microphone, or other device to receive and convert input stimulation to a signal to transfer over the bus 206 to the processor 204 or other computing device 202 component.

The network interface 218, in various embodiments, is a wired or wireless network connection device. The network interface is capable of connecting the computing device 202 to a network such as a LAN, WAN, SAN, the Internet, or virtually any other network or network type utilizing any appropriate communication protocols.

The memory 208, in some embodiments, includes the property offering database 110, the client contact database 116, a client database 214, and software 216. The client database 214 includes data representative of a client of a computing device 202 operator. In such embodiments, records in the client contact database 116 include a reference to a client record in the client database 214 to identify the source and owner of each contact record. Data in the client database 214 in various embodiments includes some or all of a client name, a client address, client telephone and fax numbers, a client email address, and reporting preferences. Reporting preferences can include a mode of delivery preference, a report frequency preference, and a reporting type preference that specifies the types of data the client prefers on reports.

The software 216 in the memory 208 includes instructions to cause the computing device 202 to receive and obtain data of properties offered for sale and store that data in the property offering database 110. The software 216 further includes instructions to cause the computing device 202 to receive and obtain client data and client contact data and store that data in the client database 214 and client contact database 116, respectively. The software 216 also includes instructions to identify and report client contacts that have a property for sale.

In some embodiments, electronic representations of client reports are communicated to the clients. Some such electronic representations include web page views of the reports over a network, such as the Internet, or an electronic document attached to an email sent to a client's email address stored in the client database. Each client receives of their own contacts having properties for sale. Other embodiments include generating a report when requested over the Internet by an authenticated client. The software 216 then retrieves the requesting client's contacts from the client contact database 116 and determines if there are any matches in the property offering database 110. If there are matches, those matches are communicated to the client in a web page that is viewable in a web browser such as Internet Explorer® available from Microsoft® Corporation of Redmond, Wash.

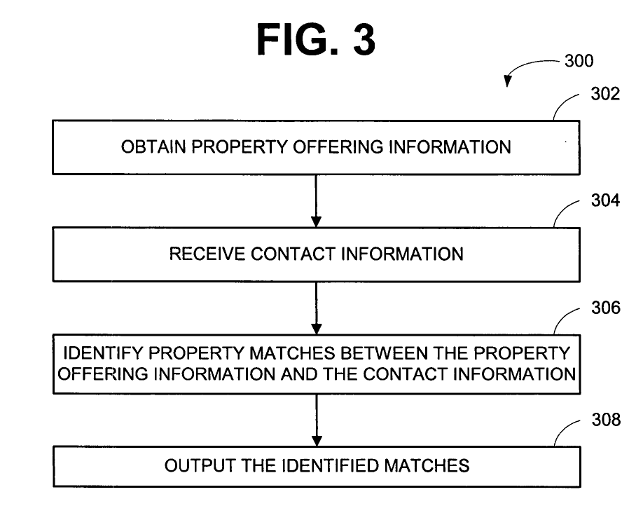

FIG. 3 is a block diagram of a method 300 according to an example embodiment. The method 300 includes obtaining property offering information 302 and receiving contact information 304. The method 300 further includes identifying property matches between the property offering information and the contact information 306 and outputting the identified matches 308.

In some embodiments, obtaining property offering information 302 includes manual entry of property offering information into a system implementing the method and storing the property offering information in a database. Other embodiments also include an automated process that queries publicly available electronic advertisements over a network and stores the query results in a database. The manual and automated database entries in these embodiments include data about the properties offered for sale. In various embodiments, this data includes a property address and an asking price.

In some embodiments, obtaining property offering information 302 further includes electronically requesting and receiving data about a property offered for sale from one or more remote sources. Received data is stored in a database. The requested and received data, in various embodiments, includes ownership and occupant data such as owner(s) name(s) and property address. The remote sources, in various embodiments, include electronic, governmental, public record property databases and clearinghouse services, electronic telephone directory services, and other electronic remote data services and sources that maintain data about property owners and occupiers.

Receiving contact information 304 includes receiving a list of contacts from a client that the client would like monitored for property offerings. The data within each list of contacts includes a record for each client contact. Each record includes data about the contact of the record. The data about the contact, in various embodiments, includes some or all of a contact name, address, phone number, and spouse name.

In some embodiments, the contact list is received in an electronic format, such as a comma delimited file, and importing the data into a database. Other embodiments include receiving contact data on paper and manually entering the data into a database. Yet further embodiments include providing an online user interface to a client where the client can enter and submit contact data to store in a database.

In some embodiments, the method 300 further includes normalizing client contact data and property offering data. This normalizing includes conforming address data within the client contact data and property offering data to a standardized address format. In some embodiments, this standardized format conforms to an address standard defined by the United States Postal Service. For example, the format in some embodiments includes determining a unique eleven-digit number for each address where the eleven-digit number is the Zip+4® code defined by the United States Postal Service plus the last two numbers of the street address of the respective property.

Identifying property matches between property offering information and the contact information 306 can include matching an address from a property offering with an address from the client contact information. In some embodiments, the matching is performed by matching a combination of address elements such as zip-code, state, city, street, house number, and unit number (if applicable). Other embodiments include performing the matching as a function of a normalized address or the unique eleven-digit number resulting from an address normalizing function.

Identifying property matches between property offering information and the contact information 306 can include verifying each match based on a name of a property owner or occupant obtained from one of the remote sources. Verifying each match by name can eliminate most, if not all, match results for client contact data that is out of date.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this inventive subject matter may be made without departing from the principles and scope of the inventive subject matter as expressed in the subjoined claims.

What is claimed is:

1. A system comprising:
a processor;
a memory coupled to the processor;
a property offering database of properties for sale stored in the memory;
a client database of client data stored in the memory;
a contact database of contact data stored in the memory, wherein each contact is associated with a client;
software stored in the memory and operable on the processor to cause the system to:
identify properties for sale owned by contacts as a function of matching a property for sale from the property offering database with a contact from the contact database; and
generate a report for each client in the client database having one or more identified contacts with a property for sale.

2. The system of claim 1, wherein each client report includes a list of the client's contacts having a property for sale.

3. The system of claim 1, wherein each client report consists of property offerings of the client's contacts who have made property offerings since a previous client report was generated.

4. The system of claim 1, wherein the software further causes the system to communicate a client report to the client.

5. The system of claim 4, wherein the software causes the system to communicate the client report to the client via electronic mail.

6. The system of claim 1, wherein the property offering database, the client database, and the contact database are tables within a relational database.

7. The system of claim 1, wherein the software is further operable to cause the system to:
normalize addresses stored in the contact database and the property offering database.

8. A system operable to:
select a client contact record from a client contact database, wherein the client contact record include data representative of a property owned by the client contact;
compare the client contact record to a database of properties for sale as a function of the data representative of the property owned by the client contact to determine if a property owned by the client contact is for sale; and
output an notice that the client contact has a property for sale if the client contact owns a property for sale.

9. The system of claim 8, wherein the data representative of a property owned by the client contact includes an address.

10. The system of claim 8, wherein the database of properties for sale includes data representative of properties offered for sale in newspaper classified advertisements.

11. The system of claim 8, wherein the system compares the client contact record to the database of properties for sale as a function of:
matching an address of the property owned by the client contact with addresses of properties offered for sale included in the database of properties for sale; and
verifying a match as a function of a name of the client contact stored in the client contact database with a recorded name of an owner of the property in the database of properties for sale.

12. The system of claim 11, wherein the matching of addresses includes normalizing the addresses prior to the matching.

13. The method of claim 8, wherein system is further operable to notify a client that the client contact has a property for sale.

14. A system comprising:
a property offering database of properties for sale;
a client contact database, wherein each entry includes a source identifier;
a module to identify matches between property offering database entries and client contact database entries; and
an output module to output identified matches.

15. The system of claim 14, wherein the output module includes:
a report generator to generate reports of identified matches associated with each unique source identifier in the client contact database.

16. The system of claim 15, wherein a generated report is a comma delimited file.

17. The system of claim 14, wherein each entry in the property offering database includes:
an address of a property for sale; and
a name of at least one owner of the property for sale.

18. The system of claim 14, wherein each entry in the client contact database includes:
one or more contact names; and
a contact address.

19. The system of claim 14, further comprising:
a data aggregation module, wherein the data aggregation module operates within the system to:
receive property offering data from property offering advertisements;
obtain property owner data of each property offering from a remote source; and
store the property offering data and associated property owner data in a database.

20. The system of claim 14, further comprising:
an output device; and
instructions operable on the system to display the output identified matches.
